(19) United States
(12) Patent Application Publication
(10) Pub. No.: US 2013/0330462 A1
(43) Pub. Date: Dec. 12, 2013

(54) Chlorellies algae pet treat

(71) Applicants: Gaytha Shores, Pearl River, LA (US); John Buddy Shores, Pearl River, LA (US)

(72) Inventors: Gaytha Shores, Pearl River, LA (US); John Buddy Shores, Pearl River, LA (US)

(21) Appl. No.: 13/492,085

(22) Filed: Jun. 8, 2012

(51) Int. Cl. A23K 1/16

(52) U.S. Cl. CPC A23K 1/16
USPC 426/644

(57) ABSTRACT

Chlorellies are pet treats made with the finest all-natural ingredients including our featured main ingredient, the super-algae Chlorella, a virtual storehouse of concentrated nutrients. The nutritional analysis is so impressive that it is purported to contain everything needed to support life on Earth. Another remarkable nutritional quality of this algae is the 50-60 percent protein content including all the amino acids and high lysine content for optimum health.

As an all-vegetable source, Chlorella also provides impressive amounts of Beta Carotene, Vitamins C, E, K and the full range of B-Vitamins. The minerals in Chlorella include calcium, iron, phosphorus, potassium, magnesium and trace amounts of manganese, iodine and zinc.

Our recipe is a special blend of human-consumption-grade ingredients as well as glucosamine and chondroitin to promote hip and joint health. Other ingredients include wheat flour, egg, whole chicken, carrots and the natural preservative potassium sorbate.

“Chlorellies” are pet treats made with the finest all-natural ingredients including our featured main ingredient, the super-algae Chlorella, a virtual storehouse of concentrated nutrients. The nutritional analysis is so impressive that it is purported to contain everything needed to support life on Earth. Another remarkable nutritional quality of this algae is the 50-60 percent protein content including all the amino acids and high lysine content for optimum health.

As an all-vegetable source, Chlorella also provides impressive amounts of Beta Carotene, Vitamins C, E, K and the full range of B-Vitamins. It has more B12 than beef liver and is an excellent source of this “feel-good” vitamin. The minerals in Chlorella include calcium, iron, phosphorus, potassium, magnesium and trace amounts of manganese, iodine and zinc.

Our recipe is a special blend of human-consumption-grade ingredients as well as glucosamine and chondroitin to promote hip and joint health. Because of the inherent high content of chlorophyll in Chlorella, what goes in green comes out green. Other ingredients include wheat flour, egg, whole chicken, carrots and the natural preservative potassium sorbate.

The Recipe:
11 cups Water
½ cup Chicken Bullion
1 lbs grated Carrots
1 whole Chicken
23 cups of Whole Wheat Flour
1 cup Whole Egg Powder
2 ½ cups Chlorella
2 oz Glucosamine
½ oz Chondroitin
4 oz Potassium Sorbate
5 oz warm Water

In a large pot combine water, chicken bullion, grated carrots and the whole chicken. Bring pot to a boil and let simmer until chicken is cooked through. Remove pot from heat and allow to cool. Once cool, remove chicken from pot and remove all bones. Place chicken meat in a food processor and puree.

In an 80 qt baking mixer, combine flour, powdered egg, chlorella powder, glucosamine, and chondroitin. Mix until thoroughly blended. Dissolve potassium sorbate in the warm water and add to chicken stock and mix.

Add the chicken stock, including the cooked carrots, and the chicken puree to the blended dry ingredients and mix thoroughly. Remove mixing bowl from blender and divide dough into manageable portions.

Flour rolling table surface with whole wheat flour and roll dough to a thickness of ¼. Cut treats into 3″×3″ squares or other shapes of the same approximate size. Brush excess flour from treats. Preheat convection oven to 325 degrees. Spray cookie sheets with non-stick spray, place treats on cookie sheets and bake for 30 minutes. Remove treats from oven and place on cooling racks until completely cooled.

Each treat contains ½ gram of chlorella. Serving recommendation is 1-4 treats a day depending on the size of your pet.

1: Chlorellies is the first pet food/treat specifically designed with algae as a main ingredient for household (non-aquatic) pets that promotes good health.
